(19) United States
(12) Patent Application Publication
(10) Pub. No.: US 2015/0223636 A1
(43) Pub. Date: Aug. 13, 2015

(54) UTILITY STICK

(71) Applicant: Randy Erwin Brouwer, Merville (CA)

(72) Inventor: Randy Erwin Brouwer, Merville (CA)

(21) Appl. No.: 14/288,381

(22) Filed: May 27, 2014

Related U.S. Application Data
(60) Provisional application No. 61/936,892, filed on Feb. 7, 2014.

(51) Int. Cl. A47J 33/00; A63B 47/02

(52) U.S. Cl. CPC A47J 33/00; A63B 47/02

(57) ABSTRACT

A utility stick device provides a reliable, compact, portable and useful tool for open fire cooking and barbequing, and for use with other attachments. It also provides a changeable tool having a variety of cooking heads and attachments, which can be compact and portable. This utility stick can include different attachments such as a marshmallow fork, a weiner fork, a net for retrieving golf balls, among others. To use, just unscrew the attachment and put on a different one. The variety of attachments can also include a popcorn basket, a popsicle pizza, a toaster tray, a pizza oven, a house duster, a mechanic's magnet, and a paint mixing attachment.

### CROSS REFERENCE TO RELATED APPLICATIONS

This application claims the priority of U.S. Provisional Application No. 61/936,892 filed on Feb. 7, 2014, inventor Randy Erwin Brouwer, entitled “utility stick.” The entire disclosure of this aforementioned provisional patent application is hereby incorporated in its entirety by reference thereto.

### STATEMENT REGARDING FEDERALLY SPONSORED RESEARCH OR DEVELOPMENT

Not applicable.

### FIELD OF THE INVENTION

The present invention relates to a multi-purpose utility stick, which can include forks for use with open fire cooking and barbequing, and also can include a handle and other attachments.

### BACKGROUND OF THE INVENTION

It is a problem in the art to make a reliable, compact, portable and useful tool for utility purposes including, but not limited to, open fire cooking and barbequing. It is also a problem to provide a changeable tool having a variety of cooking heads and/or other attachments, all of which are compact and portable, for use in open fire cooking and barbequing and/or for other utility purposes.

### SUMMARY OF THE INVENTION

From the foregoing, it is seen that it is a problem in the art to provide a device meeting the above requirements. According to the present invention, a device is provided which meets the aforementioned requirements and needs in the prior art. Specifically, the device according to the present invention provides a reliable, compact, portable and useful utility tool for open fire cooking and barbequing and/or other uses. It also provides a changeable tool having a variety of cooking heads and utility attachments, all of which are compact and portable, for use in open fire cooking and barbequing and for other utility purposes.

The device of the present invention provides a variety of attachments which can be attached and detached from one end of the utility stick, including a fork, a golf ball retriever attachment, a marshmallow stick, and a wiener stick.

Additionally, the fork include a stationary handle portion to allow turning of the utility stick, and a slideable and rotatable handle portion so that a use can readily support the utility stick for turning during use.

Other objects and advantages of the present invention will be more readily apparent from the following detailed description when read in conjunction with the accompanying drawings.

### BRIEF DESCRIPTION OF THE DRAWINGS

FIG. 1 is a front perspective view of an assembled utility stick having a utility net attachment, according to the present invention.

FIG. 2 is a schematic perspective view of a utility stick having a marshmallow stick attachment which can replace the net attachment in the device of FIG. 1.

FIG. 3 is a schematic perspective view of a utility stick having a wiener stick attachment which can replace the net attachment in the device of FIG. 1.

FIG. 4 is a schematic assembly wiew of a utility stick having handle portions and a fork-type attachment, according to the present invention.

FIG. 5 is a schematic perspective view of a liquid deflector attachment which can be used with the utility stick of FIG. 4.

FIG. 6 is a schematic perspective view of the liquid deflector attachment of FIG. 5 mounted on the utility stick of FIG. 4.

### DETAILED DESCRIPTION OF THE INVENTION

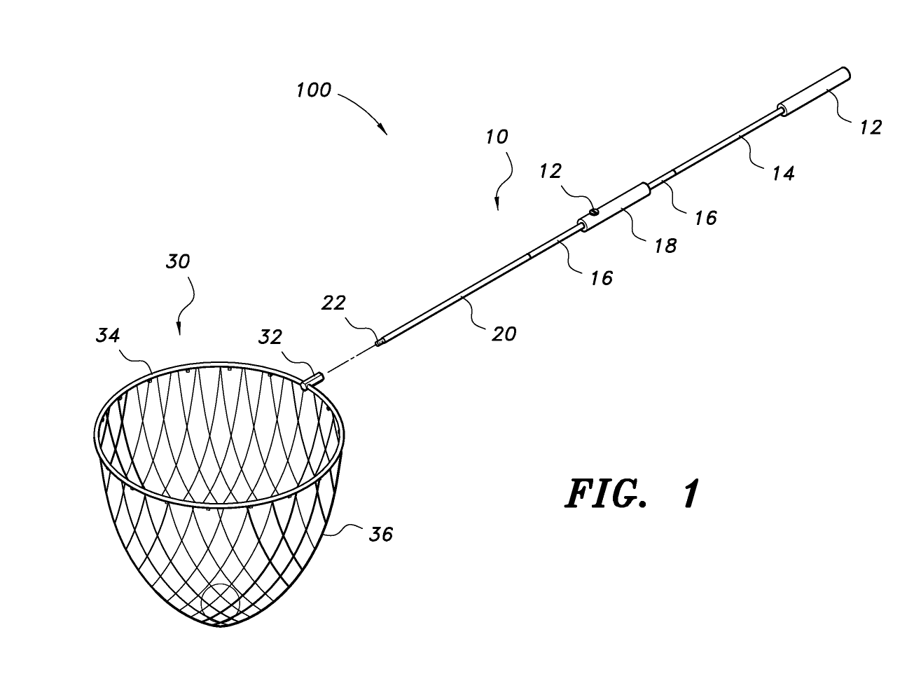

FIG. 1 is a front perspective view of an assembly 100 which includes a utility stick 10 and a utility net attachment 30. The present invention provides a reliable, compact, portable and useful utility tool, referred to herein as a utility stick 10. The utility stick 10 can be used with various attachments, including attachments for open fire cooking and barbequing, and utility attachments that can include: a house duster attachment; a mechanic's magnet attachment; and a paint mixing attachment. The device of the present invention is compact and portable, and can be readily transported, carried, and/or stored.

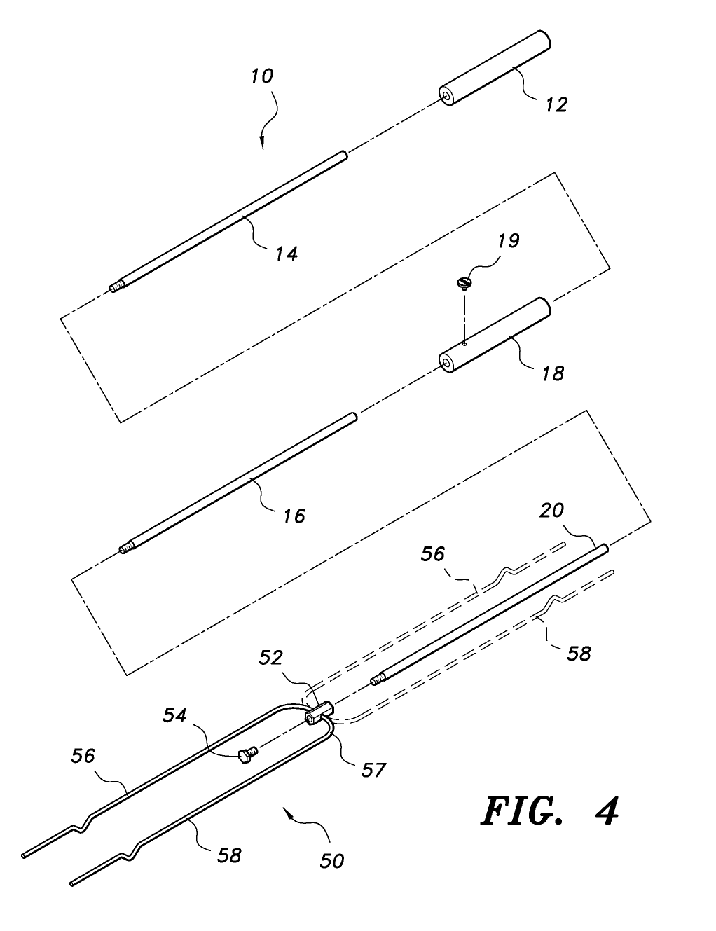

The assembly 100 includes the utility stick 10 and the utility net attachment 30. The utility stick 10 has a plurality of aluminum rod handle sections 14, 16, and 20 which can be assembled into a single long rod as shown in FIG. 4. The utility stick 10 includes a fixed handle portion 12 and a slideable handle portion 18 which can be slid along the rod handle sections 14, 16, and 20. A securing device 19, such as a set screw, is provided for securing the handle portion 18 to secure it in place along the rod handle sections, for example to the rod handle section 16 as shown in FIG. 1. A threaded end 22 projects from one end of the rod handle section 20, and is used for securement to the net attachment 30.

The net attachment 30 shown in FIG. 1 can be used as a golf ball retrieval tool, for example, and for other purposes where a net will be useful. The net attachment 30 includes a connector end 32 having a threaded recess therein for receiving the threaded projection 22; a rim 34; and a net 36. The net 36 can be formed of flexible net material, for example, or can be formed from other materials including rigid and/or semi-rigid materials.

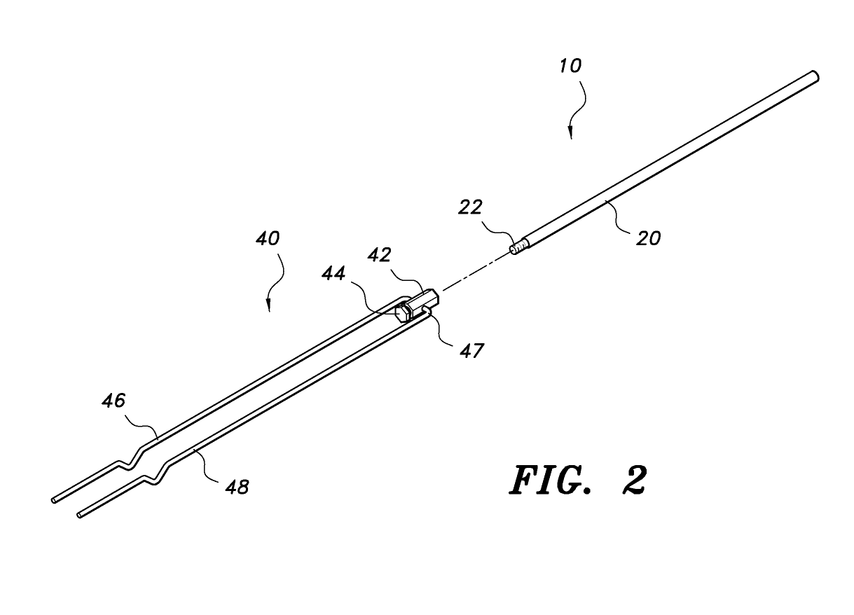

FIG. 2 is a schematic perspective view of a utility stick 10, showing the rod handle section 20 having the threaded projection 22, together with a marshmallow stick attachment 40. The attachment 40 in this embodiment replaces the net attachment shown in the device of FIG. 1.

As shown in FIG. 2, the attachment 40 includes a connector element 42 which has a threaded recess (not shown) for receiving the threaded projection 22 for securement to the rod handle section 20. The connector element 42 includes bore therethrough and a securing screw 44 communicating with the bore. The bore of the connector element 42 receives a marshmallow stick which is composed of a U-shaped fork-like portion having sections 46, 47, and 48. The section 47 passes through the bore of the connector element 42 and is secured in place by the securing screw 44. The securing screw 44 is tightened to secure the portion 47 in place. This permits the marshmallow stick (formed by elements 46, 47, 48) to be swung to a folded, safe position (such as that shown in dashed outline in FIG. 4) for storage and transport.

The metal parts of the utility stick 10 (discussed further hereunder) are preferably composed of aluminum, which disperses the heat very quickly. Handle portions, such as portions 12 and 18 of FIG. 1, are preferably composed of wood or other insulating material such as plastic or ceramic. The sliding handle portion 18 allows the user to hold the utility stick 10 in a stationary manner using two hands, which is especially useful while turning the utility stick 10 during cooking operations or moving it in different directions for other operations using other attachments.

The sliding handle portion 18 also lets the user slide it toward or away from a fork attachment, preventing the user from getting burned when taking off a marshmallow or hot dog for example. The handle portion 18 can readily be removed by the user if the user wants to use just the handle portion 12, and/or for cleaning.

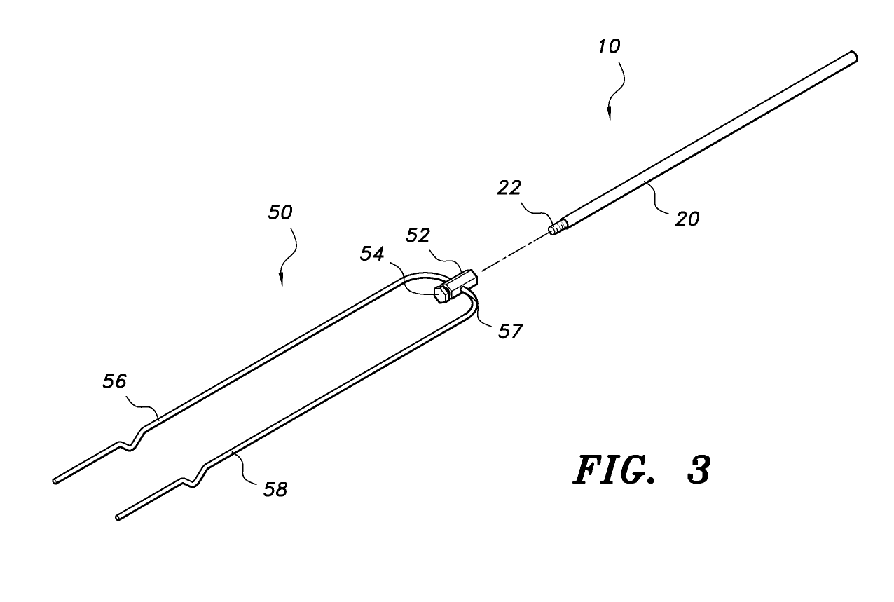

FIG. 3 is a schematic perspective view of a utility stick 10 having a wiener stick attachment 50 (which can replace the net attachment shown in the device of FIG. 1). As shown in FIG. 3, the attachment 50 includes a connector element 52 which has a threaded recess (not shown) for receiving the threaded projection 22 for securement to the rod handle section 20. The connector element 52 includes bore therethrough and a securing screw 54 communicating with the bore. The bore of the connector element 52 receives a weiner stick which is composed of a U-shaped fork-like portion having sections 56, 57, and 58. The section 57 passes through the bore of the connector element 52 and is secured in place by the securing screw 54. The securing screw 54 is tightened to secure the portion 57 in place. This permits the weiner stick (formed by elements 56, 57, 58) to be swung to a folded, safe position (such as that shown in dashed outline in FIG. 4) for storage and transport.

The utility stick 10 can be used in many different lengths. In the preferred embodiment, the preferred length is 11.5 inches long. The present invention is not limited to a specific length, or specific types of materials, and other lengths and other materials can be used suitable for the uses described herein.

FIG. 4 is a schematic assembly wiew of a utility stick 10 having the weiner attachment shown and described hereinabove with regard to FIG. 3. The folded position of the wiener fork portion 56 is shown in dashed outline in this view. As shown in FIG. 4, the sections 14 and 16 are secured together by threaded engagement (see for example the threaded ends, unnumbered, and which are schematically depicted in FIG. 4), as are the sections 16 and 20.

Also as viewed in FIG. 4, the utility stick 10 has the fixed handle portion 12 which is attached to one end of the rod handle section 14 by a threaded engagement. FIG. 4 also shows the slideable handle portion 18 and the set screw 19. While three such rod handle sections (14, 16, and 20) are shown, more such sections can be used to provide a longer utility stick 10, and fewer sections (i.e., one or two sections) for a shorter utility stick 10.

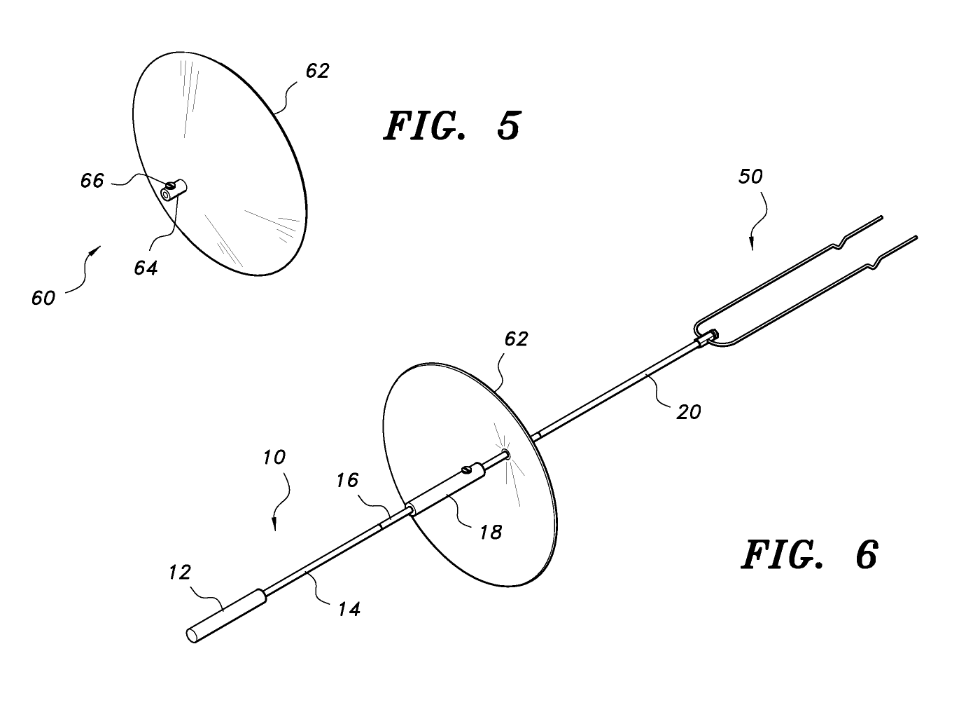

FIG. 5 is a schematic perspective view of a liquid deflector attachment 60 which can be used with the utility stick 10 of FIG. 4. The attachment 60 includes a generally conically shaped deflector body 62, connector element 64, and a set screw 66 for securing the attachment 60 along one of the sections 14, 16, and 20.

FIG. 6 is a schematic perspective view of the liquid deflector attachment 60 of FIG. 5 mounted on the utility stick 10 of FIG. 4. In this view, the utility stick 10 is used with the weiner fork attachment 50. The liquid deflector attachment 60 is useful to protect against spatters, sparks, and radiant heat.

In a further embodiment of the invention, not illustrated in the drawings, the sliding handle can also be used as an upright member having one end anchored to a fixed support such as a floor, ground, or wall; that end can be pivoted by a pivoted pivot point and ball bearing and stood upright when placed in a tripod assembly (not shown). If a rotary device such as a portable drill is attached to the stationary handle end (18) it would make the fork attachment rotate so as to operate as a rotisserie.

Examples of attachments include a fork (shown), a popcorn basket, a marshmallow stick (shown), a popsicle pizza attachment, a toaster tray, a pizza oven attachment, and a wiener stick (shown).

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. A utility stick device comprising:
plurality of handle sections, which can be assembled into a longer handle;
an end securing device to enable securing any of a variety of attachments; and
two handle portions, one of which is slideable and the other of which is fixed relative to the handle sections.

2. A utility stick as claimed in claim 1, wherein the variety of attachments can include any of a fork, a popcorn basket, a marshmallow stick, a popsicle pizza, a toaster tray, a pizza oven, and a wiener stick.

3. A utility stick as claimed in claim 1, wherein one of said variety of attachments is a net attachment, for retrieving golf balls.

4. A utility stick as claimed in claim 1, wherein one of said variety of attachments is a marshmallow fork.

5. A utility stick as claimed in claim 1, wherein one of said variety of attachments is a wiener fork attachment having a fork portion and a connector portion having a set screw; and wherein said fork portion can be pivoted with respect to said connector portion and secured into position by said set screw.
